(19) United States
(12) Patent Application Publication
(10) Pub. No.: US 2020/0319077 A1
(43) Pub. Date: Oct. 8, 2020

(54) FRACTURE LENGTH AND FRACTURE COMPLEXITY DETERMINATION USING FLUID PRESSURE WAVES

(71) Applicant: Seismos, Inc., Austin, TX (US)

(72) Inventors: Daniel Moos, Palo Alto, CA (US); Nicola Tisato, Austin, TX (US); Jakub Felkl, Austin, TX (US)

(21) Appl. No.: 16/855,546

(22) Filed: Apr. 22, 2020

Related U.S. Application Data
(63) Continuation of application No. PCT/US2018/058776, filed on Nov. 1, 2018.
(60) Provisional application No. 62/580,280, filed on Nov. 1, 2017.

(51) Int. Cl. G01N 15/08; E21B 49/00; G01V 99/00

(52) U.S. Cl. CPC G01N 15/0826; E21B 49/006; E21B 43/26; G01V 2210/646; G01V 99/005

(57) ABSTRACT

A method to measure fracture length and geometry/complexity from pressure decay and diffusion and near wellbore conductivity measurements with far-field conductivity estimates.

### CROSS REFERENCE TO RELATED APPLICATIONS

Continuation of International Application No. PCT/US2018/058776 filed on Nov. 1, 2018. Priority is claimed from U.S. Provisional Application No. 62/580,280 filed on Nov. 1, 2017. Both the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of pressure analysis, fluid diffusion, and hydraulic fracturing of subsurface rock formations as well as hydraulic fracturing process monitoring and evaluation. In particular, fracture process monitoring can be in real time while hydraulic fracturing takes place, while additional analysis of data acquired during fracture treatment can also be performed at a later time or over time.

Understanding extent and geometry of fractures in subsurface rock formations, both naturally occurring and induced such as by pumping fracturing fluid into such formations, is important to fracture treatment design engineers and fracture treatment diagnosticians. Geometry of fractures may be described in terms of the height, width, and length or “effective” height, width, and length of such fractures or systems. Fracture geometry information is important, as those relate to design parameters fracture engineers are trying to optimize using reservoir stimulation. Near-wellbore fracture geometry can be estimated from acoustic measurements, and far-field fracture properties can be estimated as will be described in this disclosure.

Methods for evaluating fracture geometry known prior to the present disclosure include fracture diagnostics, which rely on geomechanical models to compute fracture width and length. Such methods also include post shut-in analysis using reservoir flow models such as linear and bilinear flow models.

The underlying models for fracture diagnostics and post shut-in analysis may or may not be valid in any particular subsurface rock formation. There is a need for improved methods for evaluating fracture geometry as the method herein disclosed.

### SUMMARY

A method for characterizing one or more fractures in a subsurface formation according to one aspect of the present disclosure includes inducing a pressure change in a well drilled through the subsurface formation. At a location proximate to a wellhead at least one of pressure and a time derivative of pressure in the well for a selected length of time is measured. Fluid pressure is measured in the well with respect to time after a fracture pumping treatment is completed and the well is closed to fluid flow. By the characteristic of the pressure decay, at least one of a physical parameters—length, height, and width and a change in the physical parameter with respect to time of one or more fractures is determined using the measured at least one of pressure and the time derivative of pressure. This method relies on slower flow of fluid (diffusion) out of wellbore and into the fractures and into the formation post-completion of a fracturing treatment.

In some embodiments, the inducing a pressure change comprises pumping a fracture treatment.

In some embodiments, the inducing a pressure change comprises water hammer generated by changing a flow rate of fluid into or out of the well.

In some embodiments, the inducing a pressure change comprises operating an acoustic source which injects a pressure pulse into fluid within the well.

In some embodiments, the at least one of a physical parameter, and a change in the physical parameter with respect to time is determined before the pumping treatment.

In some embodiments, the at least one of a physical parameter, and a change in the physical parameter with respect to time is determined during the pumping treatment.

In some embodiments, the at least one of a physical parameter, and a change in the physical parameter with respect to time is determined after the pumping treatment.

Some embodiments use a model to arrive at near-wellbore conductivity.

Some embodiments use a model to measure far-field conductivity.

In some embodiments, far-field conductivity has a free parameter of length and a constraint of near-wellbore conductivity (kw).

In some embodiments, the near-wellbore conductivity constrains a far-field model.

In some embodiments, fracture length is calculated and measured based on the constrained near-wellbore conductivity.

In some embodiments, physical parameters are constrained by volume and composition of a treatment slurry.

A method for characterizing one or more (in a typical fracturing treatment) fractures in a subsurface formation according to another aspect of the disclosure includes inducing a pressure change in a well drilled through the subsurface formation. Pressure or its timer derivative is measured at a location proximate to a wellhead for a selected length of time. A pressure decay is measured over time after completion of pumping a fracture treatment into the subsurface formation and closing the well to fluid flow. The volume of fluid pumped is measured. At least one of a physical parameter and a change in the physical parameter with respect to time is determined for one or more fractures using the measured at least one of pressure and the time derivative of pressure, and the measured volume of fluid pumped.

Some embodiments further comprise determining fracture complexity or tortuosity, i.e., density of a fracture network near the wellbore from time behavior of other physical parameters.

In some embodiments, fracture complexity is repeatedly determined during pumping of a fracture treatment stage to optimize fracture treatment parameters.

In some embodiments fracture complexity is compared among multiple wells or fracture treatment stages to obtain more effective fracture treatment parameters.

In some embodiments the characteristics are used to improve reservoir and fracture treatment/modes.

In some embodiments, the characterization is used to model at least one of wellbore production, pressure depletion, reservoir drainage, proppant pack permeability and in-situ proppant pack properties.

In some embodiments the rate of far-field conductivity decline and near field conductivity decline is used to determine at least one of fracture complexity, overflush, and proppant placement.

In some embodiments, near field and far-field conductivity measurements are used to determine overall character, or an average character of the treatment or treated well.

### BRIEF DESCRIPTION OF THE DRAWINGS

FIG. 1 shows a wellbore intersecting a reservoir formation along with an elliptical fracture disc depicted around the wellbore.

FIG. 2 shows a pressure decay model fit to observed post-shut in well pressure decay. The figure depicts change in pressure over time. The top part of figure shows a hydraulic fracturing treatment—high pressure regions—lasting approximately 80 minutes with several ramps in pressure (and thus flow). The region of interest is highlighted as 201, curve being fitted as 202 on the inset. Bottom graph shows a zoom in on this inset of region of interest.

FIG. 3 shows a range of far field hydraulic conductivites inverted from a well with 33 fracture treatment stages. The area between the lower and higher stars corresponds to an effective radius r_{eff} of 50 and 500 feet, respectively, bounding the range of inverted values. The horizontal axis shows stages, vertical axis computed values of conductivity (kw) from the presented inversion—in Darcy-ft units. The expected conductivity (kw) value would be bound by the two assumed extremes of effective radius, marked by stars, where lower value reflects 50 ft effective radius and higher value reflects 500 foot effective radius.

FIG. 4 shows an elliptical model of a fracture.

FIGS. 5a-c show results comparing results computed for a radial, elliptical, and PKN fracture models, respectively.

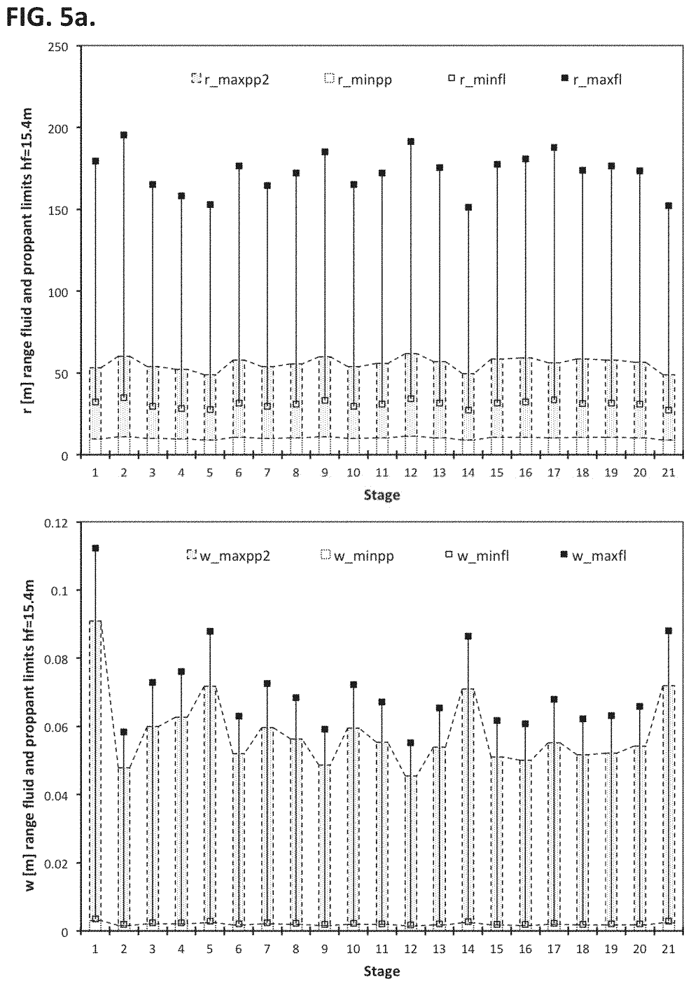

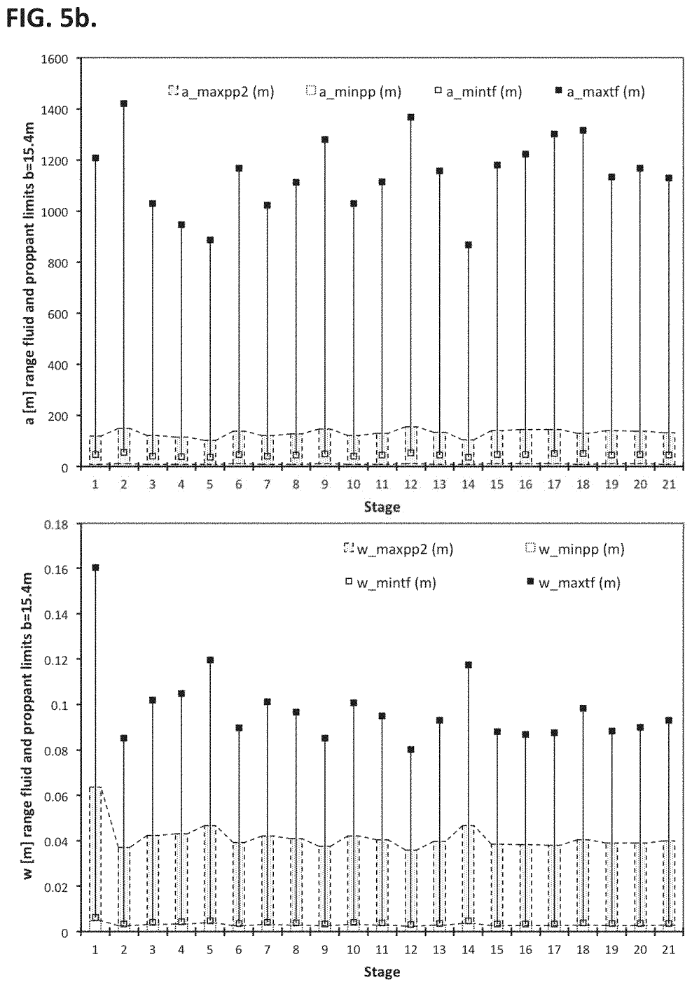

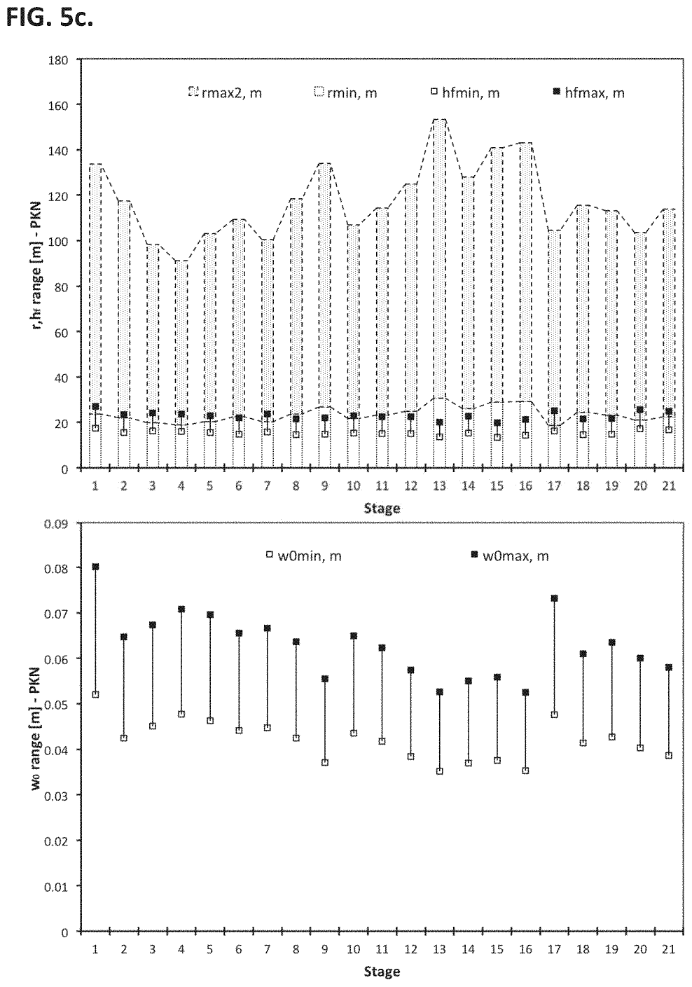

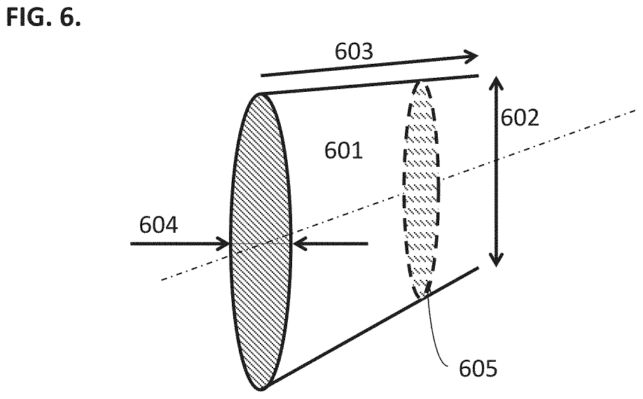

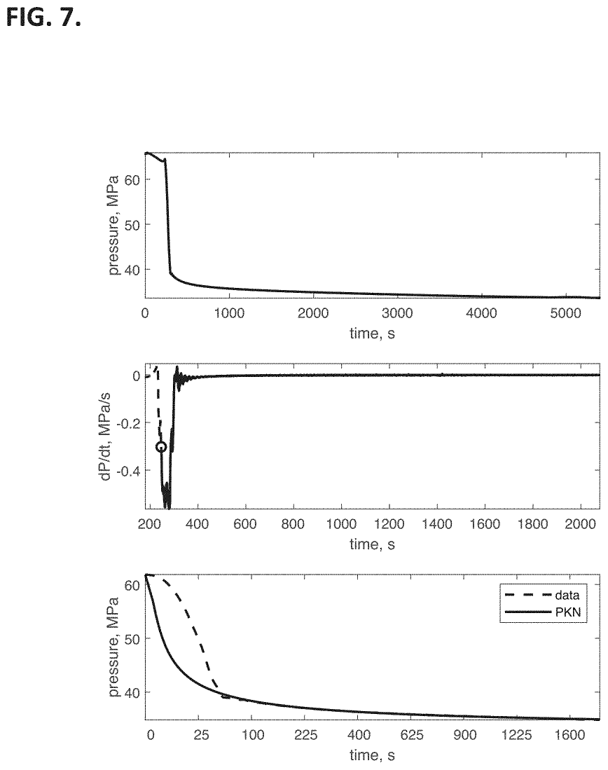

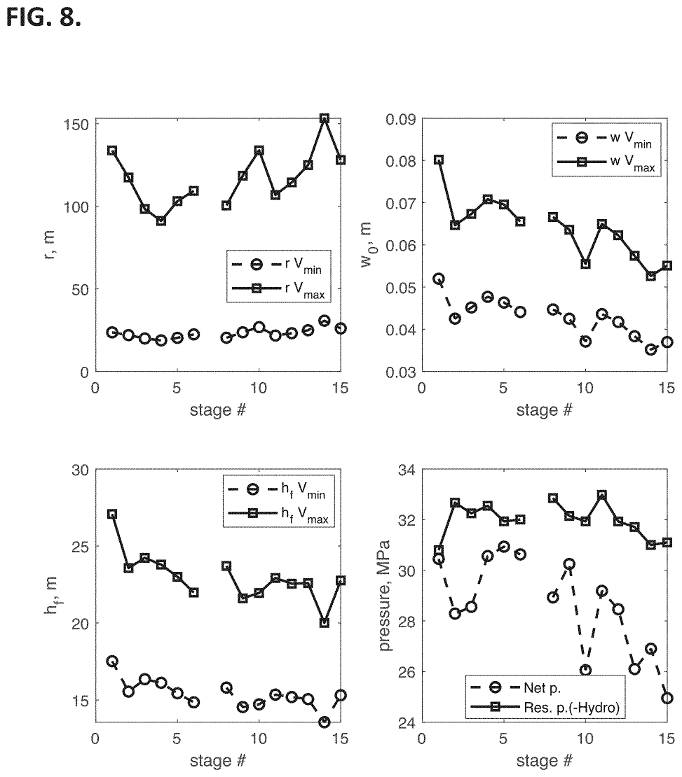

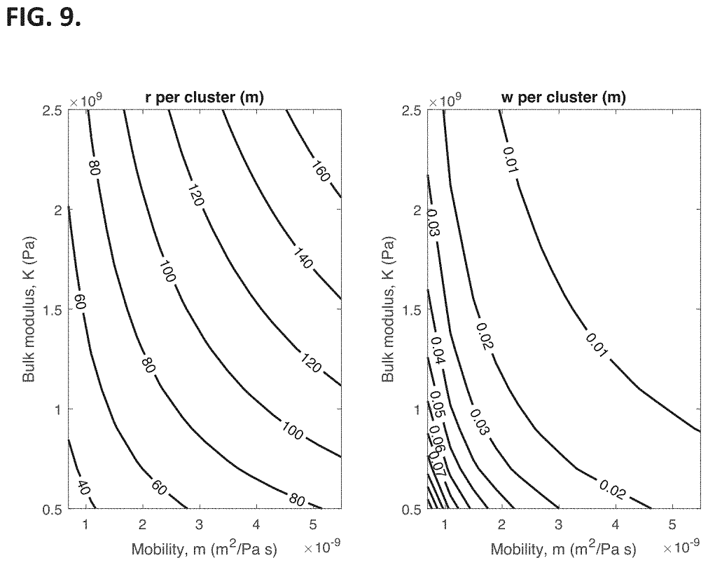

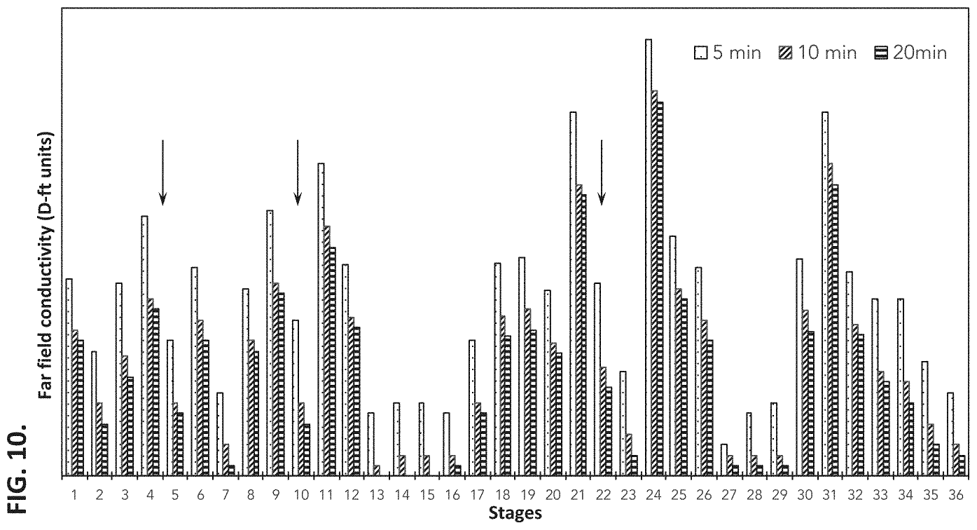

In FIG. 5a, results using inversion from radial model are presented. Top graph shows range of r in m per stage, assuming fracture height (from seismic data) of 50 feet=15.4 m. The bounds are given by maximum and minimum proppant volumes (bar graph) and maximum-minimum injected fluid volume (lines terminated by squares). Observably, the fluid bounds give larger fracture length.

In FIG. 5b, the same well and data per stage (horizontal axis) is inverted using an elliptical model with same fracture “height”=b=50 feet. Again, the top represents fracture length, and bottom represents fracture width. While fracture width is in line with radial model, fracture length range given by the elliptical model tend to be longer.

In FIG. 5c, the same well and data per stage (horizontal axis) is inverted using PKN model. The top graph shows length (r), and fracture height (hf). Fracure height range it relatively tight around ˜20 m. Fracture lengths are closer to the radial model. The bottom graph shows range of fracture widths arte wellbore (w₀) calculated using this method.

FIG. 6 shows a wing-type fracture representation used in the Perkins-Klein-Nordgen (PKN) model.

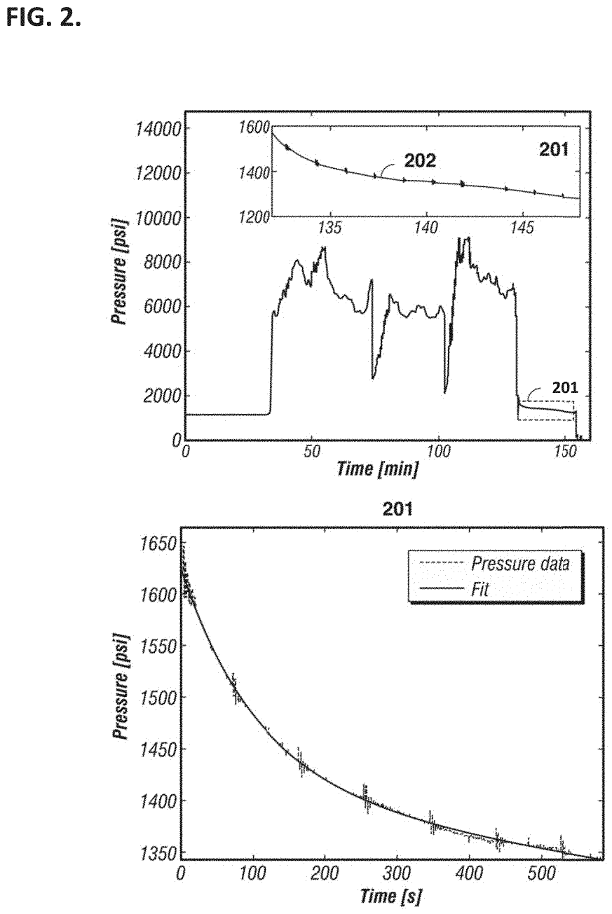

FIG. 7 shows example results of a PKN-model inversion for multiple parameters in a sample well (for one stage—stage 7 from the well in FIGS. 5a-c). Note that not all graphs start at 0. The top graph gives measured pressure as a function of time (similar to FIG. 2.) Middle graph calculates dP/dt over the first 2000 s after shut in. Finally, the bottom graph shows the characteristic of the fit between data and PKN model. Although the initial ˜75 s are poorly fit by the model, the 100 s of seconds after, i.e. the slower exponential decay in pressure, is well fit by the model.

FIG. 8 shows reservoir properties computed using the PKN model not shown in FIG. 5c on another well. Horizontal line shows stages. Net pressure and reservoir pressure in MPa are shown per stage.

FIG. 9 shows r_{eff} and w_{eff} per cluster computed as a 2D contours of mobility and bulk modulus (which are variable parameters in the inversion) to show the unconstrained space as well as the expected results. These maps have mobility on horizontal axis and bulk modulus axis. Because the actual values of bulk modulus and mobility are assumed in the models, it is useful to construct such a plot to see what fracture length (r) and width (w) values would one expect for any given mobility and bulk modulus

FIG. 10 shows far-field conductivity results computed on a well in 3 different intervals, 5, 10, and 20 minutes. Horizontal axis shows stages, vertical values of far-field conductivity (kw) in D-ft units. Of importance is the decline trend in the measurements—rapid vs. slow. The stages of interest (4, 10, 22) for a rapid decline, indicating overflush, are pointed to by an arrow.

### DETAILED DESCRIPTION

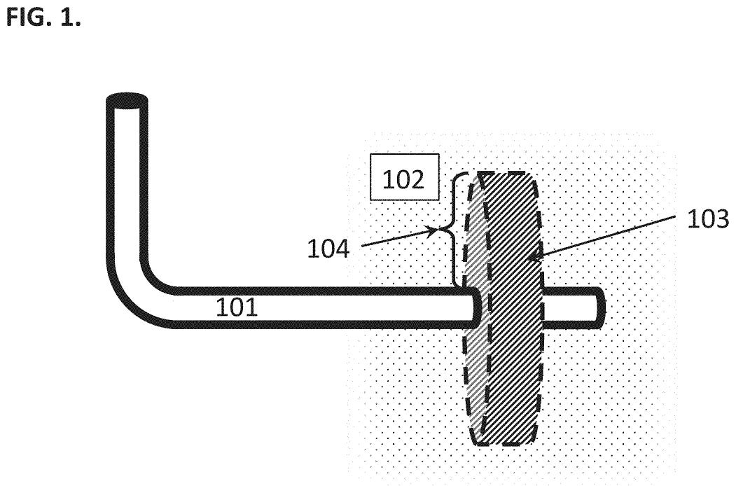

FIG. 1 shows a deviated horizontal wellbore 101 bypassing a reservoir layer 102 within a formation and an elliptical fracture 103 around the wellbore 101. In a particular case, the elliptical fracture may be symmetrical, i.e. represented as a circular disc, in other cases the fracture may take wing-like, or more complex shapes. The system has properties defined in the following description and model [units]:

P₀=˜reservoir pressure [Pa]
Pᵢ=well initial pressure[Pa]
P=pressure in the well [Pa]
Vᵢ=well volume [m³]
κ=permeability [m²]
η=viscosity [Pa s]
K=bulk modulus [Pa]
K_{b}=borehole bulk modulus [Pa]
K_{f}=fluid bulk modulus [Pa]
V=liquid volume [m³]
r_{w}=borehole radius [m]
r_{eff}=(effective) domain radius (r>>rw) [m]
w_{eff}(effective) fracture network width [m]
kw=hydraulic conductivity [m³]

The properties within the wellbore 101 are related to P, Pᵢ, Vᵢ, V and K_{b}. A fracture network whose effective hydraulic behavior is depicted by an elliptical disc 103 has properties described by: r_{eff}, L, κ, η, K. The diffusion radius R 104 is the distance to which fluid diffusion effects are apparent.

After pumping a hydraulic treatment, and referring to FIG. 2, when a wellbore main valve is closed, the pressure in the wellbore decreases as shown in region 201, following a trend curve 202. FIG. 2 depicts change in pressure over time. The top part of FIG. 2 shows a hydraulic fracturing treatment—high pressure regions—lasting approximately 80 minutes with several ramps in pressure (and thus flow). The region of interest is highlighted as 201, curve being fitted as 202 in the inset. The bottom graph shows a zoom in on this inset of region of interest.

Features from about 40-130 minutes on the top graph represent an actual hydraulic fracturing treatment. Region of interest, 201, is enlarged on the bottom graph. This disclosure shows how to use this pressure decay to model and invert for fracture properties. The small “bumps” in the pressure data are caused by acoustic pulsing and are not ordinarily fit into the decay curve as described below.

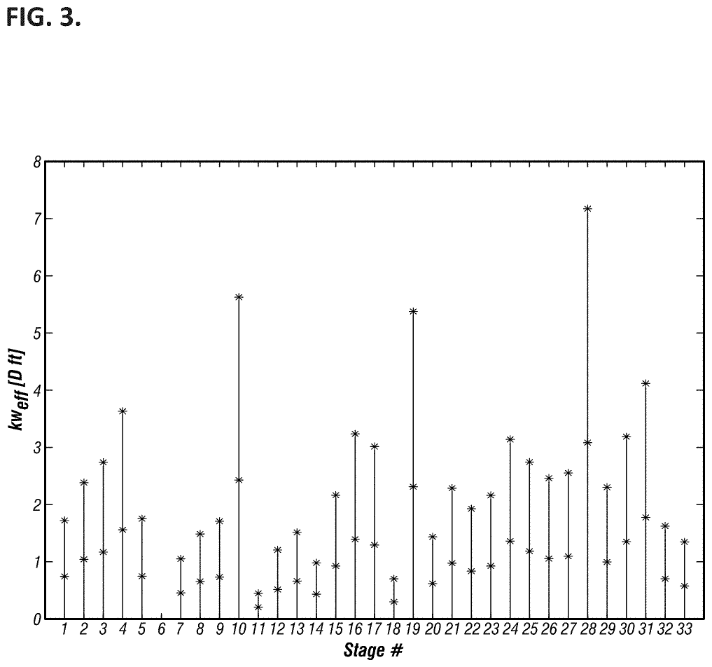

FIG. 3 shows a range of far field hydraulic conductivity (kw_{eff}) values inverted from a wellbore fracture treatment measurement set wherein the fracture treatment has 33 stages. The horizontal axis shows stages, the vertical axis shows computed values of conductivity (kw) from the presented inversion in Darcy-ft units. The expected conductivity (kw) value would be bound by the two assumed extremes of effective radius, marked by stars, where lower value reflects 50 foot effective radius and higher value reflects 500 foot effective radius. The area between the lower and higher asterisks in FIG. 3 corresponds to an effective radius r_{eff} of 50 feet and 500 feet, respectively, bounding the range of inverted values.

1. Derivation of a Model for an Elliptical Fracture

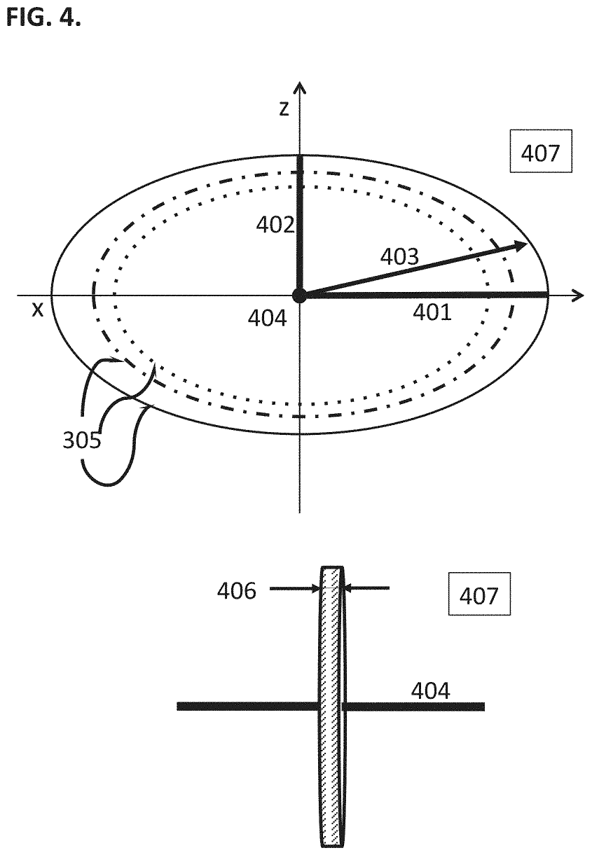

FIG. 4 in the upper panel shows an elliptical fracture of width w, shown at 406 as a cross-section around the wellbore, 404, at the wellbore center. The bottom panel of FIG. 4 shows a side view of this idealized elliptical fracture. An ellipse is defined by the length of its major axis a, 401 and its minor axis b, 402. The ellipse has a radius vector 403. Isobaric lines, 405, show concentric ellipses representing lines of equal pressure. Pressure behavior of concentric elliptical isobaric lines presents one of the assumptions used in the present model. 407 represents the surrounding formation with reservoir pressure P₀.

The basic partial differential equation for a radial flow, known as Darcy radial flow is known (e.g., Dake, eq. 5-1) as:

$$\frac{1}{r} \frac{\partial }{\partial r} ( \frac{k ρ}{μ} r \frac{\partial p}{\partial r} ) = φ c ρ \frac{\partial p}{\partial t} , \qquad ( 1 )$$

which is non-linear because of the implicit pressure dependence of the density, compressibility, and viscosity appearing in the coefficients

$$\frac{k ρ}{μ}$$

and ϕcρ.

From general Darcy's law, the flow rate q (m³/s) into the idealized elliptical fracture(s) for an infinitesimal dx can be written as:

$$q = \frac{k}{η} A \frac{d P}{d x} , \qquad ( 2 )$$

where A=area (m²), P=Pressure (Pa), k-permeability (m²), η=viscosity (Pa·s). Below, w (m) is width of the fracture. The perimeter p and area of ellipse in FIG. 4 (a>b but not a>>b) is approximately:

$$p \approx 2 π \sqrt{\frac{{a}^{2} + {b}^{2}}{2}} \to A = p h \to A = p w , \qquad ( 3 )$$

Selecting a certain ellipse and geometry,

$$a = x \to b = x ( \frac{b}{a} ) .$$

Then, substituting into eq. 2:

$$q = \frac{k}{η} 2 π \sqrt{\frac{{( \frac{x b}{a} )}^{2} + {x}^{2}}{2}} w \frac{d P}{d x} \to q = \frac{k}{η} 2 π x \sqrt{\frac{{b}^{2} + {a}^{2}}{2 {a}^{2}}} w \frac{d P}{d x} \to \frac{q}{x} d x = \frac{k}{η} 2 π w \sqrt{\frac{{b}^{2} + {a}^{2}}{2 {a}^{2}}} d P , \qquad ( 4 )$$

then integrating yields:

$$q {\int }_{{r}_{w}}^{a} \frac{1}{x} d x = \frac{k}{η} 2 π \sqrt{\frac{{b}^{2} + {a}^{2}}{2 {a}^{2}}} w {\int }_{P ( t )}^{{P}_{0}} dP \to q ln ( \frac{a}{{r}_{w}} ) = \frac{k}{η} 2 π \sqrt{\frac{{b}^{2} + {a}^{2}}{2 {a}^{2}}} w ( {P}_{0} - P ( t ) ) . \qquad ( 5 )$$

In the above equation, note that the wellbore is assumed also to be elliptical, but since r_{w}<<a that introduces minimal error. Here one can use a steady state flow from the well during pumping, however for this example, where pump flow is shut in, there is only storage from the well is defined from bulk modulus as:

$$q = \frac{{V}_{i}}{K} ( \frac{d P}{d t} ) ,$$

substituted into Eq. (5) yields:

$$\frac{{V}_{i}}{K} ( \frac{d P}{d t} ) ln ( \frac{a}{{r}_{w}} ) = \frac{k}{η} \sqrt{2 {π}^{2} \frac{( {b}^{2} + {a}^{2} )}{{a}^{2}}} w ( {P}_{0} - P ( t ) ) \to \frac{d P}{d t} = \frac{k K w \sqrt{2 {π}^{2} \frac{( {b}^{2} + {a}^{2} )}{{a}^{2}}}}{{V}_{i} ηln ( \frac{a}{{r}_{w}} )} ( {P}_{0} - P ( t ) ) , \qquad ( 6 )$$

one then obtains the expression:

$$\frac{d P}{d t} = C ( {P}_{0} - P ( t ) ) and C = \frac{k K {w}_{eff} \sqrt{2 {π}^{2} \frac{( {b}^{2} + {a}^{2} )}{{a}^{2}}}}{{V}_{i} ηln ( \frac{a}{{r}_{w}} )} . \qquad ( 7 )$$

where C is a decay constant in the below solution of the pressure dissipation from the wellbore to the reservoir:

P(t)=P₀+(Pᵢ−P₀)e^{-Ct} (8)

where Pᵢ is the initial pressure at the wellbore 304 and P₀ is a proxy for reservoir pressure 307.

Decay constant C is related to the properties of the fracture. FIG. 2 depicts an exponential fit to pressure measurement data during post shut-in (wellbore valve closed after pumping is stopped) time period. A full stage fracturing treatment is depicted in the top graph. Its inset 201 with a pressure decay curve 202 are enlarged in the bottom graph of FIG. 2. The fit, taking the general form of Eq. (5) agrees well with the observed data.

This pressure decay fit, Eq. (8) as depicted on pressure measurements as shown in FIG. 2 provides 3 values: P₀, Pᵢ, C. Quantity C is the fit decay exponent,

$$C = \frac{{kKw}_{eff} \sqrt{2 {π}^{2} \frac{( {b}^{2} + {a}^{2} )}{{a}^{2}}}}{{V}_{i} ηln ( \frac{a}{{r}_{w}} )} . \qquad ( 9 )$$

Note that kw is the far field fracture conductivity. It is possible to obtain C from pressure decay data. One can also invert for a. The two unknowns, K and η, are petrophysical fluid physical parameters. Since these parameters are not precisely known, one can consider a reasonable range and calculate r, w. V(w, r)—the range, and include figures “maps”, such as shown in FIG. 9 to see which range the r and w quantities fall given some reasonable assumption on subsurface properties.

As mentioned, constant C in Eq. (9) is a decay constant which is related to the fluid flow properties of the fracture. Material volume provides additional constraint on the fracture dimensions. In general, this pressure decay behavior will occur within a diffusion radius, R (104 in FIG. 1). This may also be defined as R, or a radius of investigation, R=Rᵢ. Additional constraints may be obtained from near-field pulsed pressure measurements and physical properties of materials. An example constraining the effective far-field conductivity is shown in FIG. 3 using lines with top and bottom asterisks representing different radii of investigation where diffusion is assumed to play significant role. Top values correspond to Rᵢ=500 feet, bottom to Rᵢ=50 feet. The asterisks indicate the region for which the calculated conductivity should fall

During hydraulic fracturing, the (typically known) volume of proppant pumped into the formation is Vₚ, and V is the (often larger) total volume of fractures. Those quantities of material volume can be used to further constrain solutions and fracture dimensions based on conservation of matter (i.e., fracture volume should not be smaller than the volume of injected proppant Vₚ nor larger than the volume of the pumped treatment fluid Vₛ). Define c as proppant porosity (or fill-fraction), e.g., 0.4, and then:

$$V = \frac{{V}_{p}}{1 - Φ} . \qquad ( 10 )$$

Solving given a known volume of the fluid injected, eq. (10) gives:

$$π a bw = V = \frac{{V}_{p}}{1 - Φ} \to w = \frac{{V}_{p}}{( 1 - Φ ) a b π} \qquad ( 11 )$$

and substituting w into modified Eq. (9), noting that w_{eff}=w:

$$C = \frac{k K w \sqrt{2 {π}^{2} \frac{( {b}^{2} + {a}^{2} )}{{a}^{2}}}}{{V}_{i} ηln ( \frac{a}{{r}_{w}} )} \to \frac{\sqrt{2 {π}^{2} \frac{( {b}^{2} + {a}^{2} )}{{a}^{2}}}}{ln ( \frac{a}{{r}_{w}} )} = \frac{C {V}_{i} η}{k w K} \to \frac{\sqrt{2 {π}^{2} \frac{( {a}^{2} + {b}^{2} )}{{a}^{2}}}}{a ln ( \frac{a}{{r}_{w}} )} = \frac{C {V}_{i} η b π ( 1 - Φ )}{k K {V}_{p}} \qquad ( 12 )$$

which may be simplified to:

$$\frac{\sqrt{\frac{( {a}^{2} + {b}^{2} )}{{a}^{2}}}}{ a ln ( \frac{a}{{r}_{w}} )} = \frac{C {V}_{i} η b ( 1 - Φ )}{\sqrt{2} k K {V}_{p}} . \qquad ( 13 a )$$

D may be defined more simply as

$$D : = \frac{\sqrt{( {a}^{2} + {b}^{2} )}}{{a}^{2} ln ( \frac{a}{{r}_{w}} )} . \qquad ( 13 b )$$

One can solve the inverse of (13), to provide the following:

$$\frac{{a}^{2} ln ( \frac{a}{{r}_{w}} )}{\sqrt{( {a}^{2} + {b}^{2} )}} = \frac{\sqrt{2} k K {V}_{p}}{C {V}_{i} η b ( 1 - Φ )} \qquad ( 14 )$$

for fracture length, a, using for example numerical methods. Quantity b (fracture height) can be constrained using known external factors, such as the layer thickness, microseismic data, or by other known or estimated means. The volume of proppant or fluids can be adjusted based on known volumes injected.
If it is considered that the upper limit of the fracture volume is equal to Vₛ, Eq. (14) becomes:

$$\frac{{a}^{2} ln ( \frac{a}{{r}_{w}} )}{\sqrt{( {a}^{2} + {b}^{2} )}} = \frac{\sqrt{2} {kKV}_{s}}{C {V}_{i} η b} . \qquad ( 14 b )$$

2. Special Case of Radial Fracture and Estimating r_{eff}

For a special case of a radial (cylindrical, or disc-shaped fracture), we have:

a=b=r_{eff}=r. (15)

Then, for a radial flow in a circle C in Eq. (9) simplifies as:

$$C = \frac{k K w \sqrt{2 {π}^{2} \frac{( {b}^{2} + {a}^{2} )}{{a}^{2}}}}{{V}_{i} ηln ( \frac{a}{{r}_{w}} )} = \frac{k K w \sqrt{2 {π}^{2} \frac{2 {r}^{2}}{{r}^{2}}}}{{V}_{i} η ln ( \frac{r}{{r}_{w}} )} = \frac{kKw 2 π}{{V}_{i} ηln ( \frac{r}{{r}_{w}} )} . \qquad ( 16 )$$

Volume in the circular/radial model is also:

$$V = w π {r}^{2} = \frac{{V}_{p}}{1 - Φ} \to w = \frac{{V}_{p}}{π {r}^{2} ( 1 - Φ )} , \qquad ( 17 )$$

where r=r_{eff} for simplicity. Then one can rewrite Eq. (17) as follows:

$$C = \frac{2 π k w K}{η {V}_{i} ln ( \frac{r}{{r}_{w}} )} = \frac{2 k {V}_{p} K}{η {V}_{i} ln ( \frac{r}{{r}_{w}} ) ( 1 - Φ ) {r}^{2}} \to {r}^{2} ln ( \frac{r}{{r}_{w}} ) = \frac{2 k {V}_{p} K}{C η {V}_{i} ( 1 - Φ )} . \qquad ( 18 )$$

Eq. (18) is non-linear with respect to r, but can be solved using, for example, least squares regression. Quantity (length) r_{eff}=r can be calculated with known or assumed k, K, Vₚ, Vᵢ, C, and Φ. In case of multiple fractures, i.e., in case one calculates r and w per cluster, Vₚ and Vᵢ—assuming symmetry among the fractures—should be divided by the number of clusters. By fitting short time windows and plotting the change in the decay parameter, it is possible to estimate propped fracture length.

To arrive at an estimate of r_{eff} (which can be used as a proxy for fracture length), one can assume a given mobility (k/η) for the injected proppant, and a certain bulk modulus K expressed as in ref. Norris, 1989. The low frequency tube-wave speed may be generally written in term of the mass density of the borehole fluid [symbol] _{B}, the effective bulk modulus, K*:

$$v = {( {K}^{*} \cdot {ϱ}_{B} )}^{\frac{1}{2}} ,$$

where

$$\frac{1}{{K}^{*}} = \frac{1}{{K}_{B}} + \frac{1}{1 - f} ( \frac{1}{{M}_{F}} + \frac{f}{{M}_{T}} ) .$$

Here K_{B} is the modulus of the wellbore fluid, f is the volume fraction a wellbore tool occupies (no tool in this case, f=0), and M_{f}, MT are moduli that depend upon the formation and the tool (if present) respectively. The low frequency results do not require that the tool be concentric with the wellbore, only that their axes be parallel. Then

$$\frac{1}{{K}^{*}} \approx \frac{1}{{K}_{B}} + \frac{1}{( 1 - f ) {M}_{F}} ,$$

with f=0 (no tool). Formation modulus, M_{F} is:

$${M}_{F} = μ\_F \frac{1 - {v}_{c} + ( \frac{{f}_{c}}{2} ) ( \frac{{μ}_{c}}{{μ}_{F}} - 1 ) ( 1 - β {v}_{C} )}{1 - {v}_{c} + ( \frac{{f}_{c}}{2} ) ( \frac{{μ}_{c}}{{μ}_{F}} - 1 ) ( 1 - β {v}_{C} )} .$$

Ultimately, the bulk modulus can be written as:

$$\frac{1}{K} = \frac{1}{{K}_{b}} + \frac{1}{{K}_{f}} , \qquad ( 19 )$$

where K_{b} is the borehole bulk modulus [Pa], and K_{f} is fluid bulk modulus [Pa]. The K=K* can also be represented by a “typical” or expected properties of the wellbore and fluid in question.

In FIG. 5a, results using inversion from radial model are presented. The top graph shows range of r in m per stage, assuming fracture height (from seismic data) of 50 feet=15.4 m. The bounds are given by maximum and minimum proppant volumes (bar graph) and maximum-minimum injected fluid volume (lines terminated by squares). Observably, the fluid bounds give larger fracture length.

In FIG. 5b, the same well and data per stage (horizontal axis) is inverted using an elliptical model with same fracture “height”=b=50 feet. Again, the top graph represents fracture length, and bottom represents fracture width. While fracture width is in line with radial model, fracture length range given by the elliptical model tend to be longer.

In FIG. 5c, the same well and data per stage (horizontal axis) is inverted using PKN model (described below). The top graph shows length (r), and fracture height (h_{f}). Fracture height range it relatively tight around ˜20 m. Fracture lengths are closer to the radial model. The bottom graph shows range of fracture widths are wellbore (w₀) calculated using this method.

Because the results are sensitive to chosen bulk modulus and mobility parameters, one can then plot results as depicted in FIG. 9, which shows r_{eff} and w_{eff} per cluster computed as a 2D contours of mobility and bulk modulus (which are variable parameters in the inversion) to show the unconstrained space as well as the expected results. These maps have mobility on horizontal axis and bulk modulus axis. Because the actual values of bulk modulus and mobility are assumed in the models, it is useful to construct such a plot to see what fracture length (r) and width (w) values would one expect for any given mobility and bulk modulus

3. Perkins-Kern Model (PK(N))

Another model, shown below by a way of example, can be used for inversion processing. For this Perkins-Kern Model (PK(N)), refer to FIG. 6, where a representative fracture 601 is a wing fracture of height h_{f}, 602, length x, 603, and maximum width at the wellbore, w_{w,0}, 604. This model is presented in Unified Fracture Design, by M. Economides (pp 51 et. seq.). The assumptions disclosed in the Economides reference may be used herein as well.

$$\begin{matrix}{w}_{o} = \frac{2 {h}_{f} {P}_{n}}{{E}^{′}} , & ( 20 ) \\ {E}^{′} = \frac{E}{1 - {v}^{2}} , & ( 21 )\end{matrix}$$

where E′ is the plane strain modulus, Pn is the net pressure, E and v are the formation Young's modulus and Poisson's ratio, respectively. Note that w₀, i.e., the fracture width at the borehole, is a function of Pₙ:

$$\begin{matrix}\frac{d {P}_{n}}{d x} = \frac{- 4 η {q}_{i}}{π {w}_{o}^{3} {h}_{f}} , & ( 22 ) \\ {w}_{0} = {{w}_{w , 0} ( 1 - \frac{x}{X} )}^{\frac{1}{4}} , & ( 23 )\end{matrix}$$

Flow rate is, after substituting for w₀ from Eq. (20):

$${q}_{i} = \frac{π {w}_{o}^{3} {h}_{f}}{- 4 η} \frac{{dP}_{n}}{dx} = \frac{8 {π ( {h}_{f} )}^{4} {P}_{n}^{3} d {P}_{n}}{- 4 η d x} = \frac{- 2 π {h}_{f}^{4}}{η {E}^{′3}} {P}_{n}^{3} \frac{d {P}_{n}}{d x} . \qquad ( 24 )$$

Solving for qᵢ and integrating between r_{w} (borehole radius) and x (fracture length 503):

$$\begin{matrix}{q}_{i} d x = \frac{- 2 {πh}_{f}^{4}}{{{ηE}^{′}}^{3}} {P}_{n}^{3} d {P}_{n} \to {\int }_{{τ}_{w}}^{X} {q}_{i} d x = \frac{- 2 π {h}_{f}^{4}}{η {E}^{′3}} {\int }_{{P}_{0}}^{{P}_{i}} {P}_{n}^{3} d {P}_{n} & ( 25 ) \\ {q}_{i} = \frac{- π {h}_{f}^{4}}{2 η {{E}^{′}}^{3}} \frac{{P}_{o}^{4} - {P ( t )}^{4}}{X - {r}_{w}} . & ( 26 )\end{matrix}$$

The flow rate is also related to the wellbore storage and to the bulk modulus (K), which is a function of the fluid and borehole compliance:

$$K = - {V}_{0} \frac{d P}{d V} \to \frac{d V}{d t} = - \frac{{V}_{i}}{K} \frac{d P}{d t} \qquad ( 27 )$$

setting normalization, P₀=0, one may calculate the overpressure decay into respect the reservoir pressure (P₀) that may be assumed to be a relative zero:

$$\frac{{V}_{i}}{K} \frac{d P}{d t} = \frac{π {h}_{f}^{4}}{2 η {E}^{′3}} \frac{{P}_{o}^{4} - {P ( t )}^{4}}{X - {r}_{w}} \to \\ \frac{d P}{d t} = \frac{π {h}_{f}^{4}}{2 η {E}^{′3}} \frac{K}{{V}_{i} ( X - {r}_{w} )} {P ( t )}^{4} \qquad ( 28 )$$

This ordinary differential equation has the following solution:

$$\begin{matrix}P ( t ) = \sqrt[3]{\frac{- {P}_{i}^{3}}{( 3 C {P}_{i}^{3} t - 1 )}} + c , where & ( 29 ) \\ C = \frac{π {h}_{f}^{4} K}{2 η {E}^{′ 3} {y}_{i} ( X - {r}_{w} )} & ( 30 )\end{matrix}$$

for t→∞, P(t)→P₀ however, setting P₀=0, thus it can be considered c=0 as the first term of Eq. (28) for t→∞ goes to zero.
The fracture aperture as a function of x (the distance from the borehole) is:

$$w ( x ) = {{w}_{0} ( 1 - \frac{x}{X} )}^{1 / 4} \qquad ( 31 )$$

And the volume of a fracture wing is:

$$V w = \frac{1}{2} {\int }_{0}^{X} ( \frac{π {w}_{0} {h}_{f}}{2} {( 1 - \frac{x}{X} )}^{1 / 4} ) \\ dx = {\int }_{0}^{X} ( \frac{π}{4} {w}_{0} {{h}_{f} ( 1 - \frac{x}{X} )}^{1 / 4} ) d x . \qquad ( 32 )$$

And integrating:

$$V w = \frac{- π X {h}_{f} {{w}_{0} ( 1 - \frac{x}{X} )}^{5 / 4}}{5} \qquad ( 33 )$$

That for x=X is zero, and for x=0 is:

$$V w ( x = 0 ) = - \frac{π X {w}_{0} {h}_{f}}{5} , \qquad ( 34 )$$

### Thus:

$$\begin{matrix}V w = \frac{π X {w}_{0} {h}_{f}}{5} , and & ( 35 ) \\ {h}_{f} = \frac{5 V π}{X {w}_{0}} \to V = \frac{{rw}_{0} {h}_{f}}{5} . & ( 36 )\end{matrix}$$

Volumes of proppant Vp and pumped fluid Vf are the size limits for Vw, as the lower limit is minimum volume (proppant pack only, assumes maximum fluids leak off into the formation) and higher limit includes volume of proppant and fluid pumped (assumes no fluid lost too the formation, i.e. no leakoff). Thus, by using Vw=Vp and Vw=Vf one can perform an inversion to calculate a range of w₀, h_{f} (fracture height) and X. Pane strain modulus E′ is calculated from E′=E/(1−η²). Pn is calculated from the inversion. Note, that Vw refers to a volume of half wing of a fracture. Some example effective fracture dimensions and geometry results are in FIG. 5c. Intermediate results are shown graphically in FIGS. 7, 8, which show, respectively, example results of a PKN-model inversion for multiple parameters in a sample well (for one stage—stage 7 from the well in FIGS. 5a-c). Note that not all graphs start at 0. The top graph gives measured pressure as a function of time (similar to FIG. 2.) The middle graph calculates dP/dt over the first 2000 seconds after shut in. Finally, the bottom graph shows the characteristic of the fit between data and PKN model. Although the initial ˜75 s are poorly fit by the model, the 100 seconds of seconds after, i.e., the slower exponential decay in pressure, is well fit by the model; and wherein FIG. 8 shows reservoir properties computed using the PKN model not shown in FIG. 5c on another well. Horizontal line shows stages. Net pressure and reservoir pressure in MPa are shown per stage.

Although only 3 models were presented, other possible models can be applied to the fractures and parameters inverted accordingly. FIGS. 5a-c. Shows a comparison of results using similar elliptical and radial fracture model parameters. Other applicable models can account for different fracture geometries, or different flow patterns (i.e. fluid leaking off through the sides of the fractures, vs. the tip only, or a combination of both). The inversion from the data can be done algorithmically using a microcomputer and appropriate software.

4. Application of Inverted Results

The quantities for which the fracture properties can be calculated can be used to inform reservoir or geomechanical models, as well as determine additional effective properties of a fracture system. Because the diffusive processes take longer time scales, they also affect and are driven by the farther reaches of the stimulated fracture volume. Namely, the far-field (tens of feet or more away from the wellbore) conductivity can be determined. Also, in combination with near field conductivity within few feet of the wellbore, some interesting observations and conclusions can be drawn for the following 4 states:

A. both near-field (NF) and far field (FF) conductivity are high
B. NF is high and FF is low
C. NF is low and FF is high

### D. Both NF and FF are low

In case A, it is possible that the fracture network created had a balance between stimulating near-wellbore and far-field areas of the reservoir. In case B, a fracture near-wellbore may be much wider than farther, which can also indicate higher near-wellbore complexity. In case C, the production may be limited by the low conductivity in the near-wellbore region. In case D, the treatment probably did not go as planned.

Using trends over time in far field conductivity, near-field conductivity, or both, one can also conclude about flush state (overflush, underflush), proppant placement and fracture closure. Understanding overflush can help operators improve proppant placement. Combining near-field and far-field conductivity trends and assuming a geometry of a fracture (e.g., elliptical, triangular, etc.) as well as flow, a fracture length can also be computed.

For example, in FIG. 10, highlighted are stages where the far field fit conductivity over initial 5 minutes significantly decreased at 20 minutes. This may indicate a rapid FF fracture closure and leakoff, potentially indicating little proppant was placed at the initial estimated fracture length.

5. Method Implementation

The description below uses specific examples but is not necessarily the only intended or possible implementation or use of the disclosed methods. A person having skill in the art can come up with similar implementations to the same goals.

The general implementation of the disclosed method analyzes post shut-in pressure decay to determine effective fracture extent. It uses fit to a “steady-state” exponential pressure decay model and includes a post shut-in near-field width that may be used to constrain the inversion. By fitting short time windows and plotting the change in the decay parameter, it is possible to estimate the propped fracture length given a sufficient time after shut in (minutes or more). The radius of investigation (10 is a function of time (longer times enable investigating farther in the fracture)—a sufficient time after shut in is required for a good fit. A series of longer time fits enables one to see changes in the fracture properties over time.

The steps in implementing the method include:

1. Performing a hydraulic fracturing or pressure treatment in a wellbore
2. Measuring pressure after shut-in (typically several minutes are required)
3. Selecting a fracture model to use (elliptical, radial, or other)
4. Fitting an exponential pressure decay curve with respect to time for the acquired pressure data, wherein the fitting comprises determining a decay constant C
5. Using the exponential decay constant C and the appropriate model to invert for fracture properties accordingly, e.g., fracture conductivity
6. In addition, knowledge of other factors can be used to constrain the inversion, for example: expected fracture height (fracture conductivity (far-field), fracture conductivity or width in near-field, the volumes and types of proppant, slurry, injected fluid, and other known physical characteristics.

Using the PKN model (Step 3) provides height, width, and length without the need to constrain one and calculate (invert) for the other, thus the PKN model requires steps 1-2, providing a fit, and using other factors to constrain the inversion.

Assumptions made in generating methods according to the present disclosure are that the volume of the propped part of a fracture (that part which is supported by solid particles called “proppant”) is (1) smaller than the total volume of the fracture, (2) the volume of the fracture is smaller than the volume of injected fluid, (3) the flow occurs primarily out of the edge of the propped fracture rather than out of its surface for a variety of reasons; leakage out of the walls of the propped part of the fracture will be smaller than leakage out of the ends of the fracture, and (4) a negligible background permeability among others mentioned. Such leakage relationship is largely because the area of the propped fracture is much smaller than that of the total fracture system and the flow out of the walls of that system beyond the propped part is in fact fed by radial flow out of the propped fracture which is what the present model assumes. This contrasts with the bilinear flow model which assumes all flow is out of the walls of the fracture into a perpendicular system connected to that fracture.

Additional assumptions are that (1) the propped part of the fracture is smaller than the total fracture, and (2) that flow occurs primarily out of the edge of the propped fracture rather than out of its surface for a variety of reasons, and that leakage out of the walls of the propped fracture will be smaller than leakage out of the ends of the fracture, largely because the area of the propped fracture is much smaller than that of the total fracture system—and the flow out of the walls of that system beyond the propped portion is in fact fed by radial flow out of the propped fracture. This contrasts with the bilinear model which assumes all flow out of the walls of the fracture into a perpendicular system connected to that fracture. As described in the disclosure, a variety models can be used to arrive at a range of results, that can be used to inform hydraulic fracturing treatment.

In addition to measuring fracture length, by measuring longer times (e.g., 5, 10, 20 minutes) it is possible to capture evolving fracture properties and reservoir properties, i.e. reservoir pressure (P₀) and volume as a function of time, FIGS. 6, 10. The fracture behavior can be estimated as well: The volume of fluid in the fractures (Φ) will change with P₀ decline due to leak off. The rate at which this volume changes is related to the dominant modes of leak-off from the fracture. A more complex fracture—based on dominant fluid loss modes may experience a faster initial leak-off as in highlighted stages on. Thus a change in Φ is a measure of fracture complexity. This allows not only to measure fracture length, but also estimate level of fracture complexity (FIG. 10).

The method enables estimating the effective fracture extent (radius, length) of a propped fracture. The method can use the near-field conductivity measurements according to a method similar to that disclosed in Dunham et al. publication referred to in the Background section herein, also referred to as the “reflectivity method”, or “near-field method.”

An additional example method according to the present disclosure may include the following actions.

1. Compute a near field k (permeability) and w₁ (fracture width) product using tube wave inversion. Also compute r1, a radius equal to the diffusion length computed from those properties. Such computations are described in the Dunham (2017) reference cited above.

2. Compute an equivalent fracture to match separate information based on pressure decay after shut-in using a single, unitary thickness layer by a pressure diffusion method (also called a far-field method); choosing an initial length and computing far-field “kw” (conductivity, product of permeability and fracture width, FIG. 7) by fitting pressure decay as described with reference to FIGS. 1, 2 and 3.

The above mentioned approach could be rerun in the reverse order, that is perform a pressure decay (far-field) inversion first, then use the results of the pressure decay inversion to constrain the near-field (reflectivity) inversion.

By comparing stage-to-stage (for a multiple stage fracture treatment) parameters, correlating results with fluid production or other measurements over at least 2 stages or at least 2 wells, one can obtain more effective fracturing procedures. Besides comparing results stage to stage (even across wells in a given formation), a global parameter defined as a sum or stage average (median) of the values for the well can be defined for a well to compare among a set of wells or treatments.

Note, that the model in methods according to the present disclosure assumes a fixed fracture length after shut in. In reality, a fracture may still be growing (extending away from the well) when the fracture fluid pumps stop, and it is the extra volume that causes the fluid pressure to drop after shut in. Sometimes the initial shut in pressure is assumed to be the pressure at which growth stops. The boundary condition at the end of the fracture is with that assumption a pressure equal to the least stress. This is consistent with the model assumption that flow is out the end of the fracture against a fixed pressure. But, it is not consistent with assuming a constant radius fracture with a constant pressure at that radius equal to the reservoir pressure. If the effective radius is fixed as the outer edge of the proppant in a fracture, then a correct model is one a decreasing pressure with respect to time at that point starting at least stress and dropping towards reservoir pressure as the fluid, but not the proppant, leaks out of the fracture.

Some other uses of the methods of the present disclosure include constraining fracture models based on measured far-field quantities. If a proppant pack permeability is constrained, one can invert for fracture width. Conversely, if fracture width is constrained, one can invert for proppant pack permeability. Also, production analysis can be tied to the measured quantities to optimize future treatments and production. Determining some parameters of the created fractures and combining those with reservoir models, production data, or other known factors affecting the treatment, the fracture parameters can be used to model at least one of wellbore production, pressure depletion, reservoir drainage, proppant pack permeability and in-situ proppant pack properties in the well.

Wellbore production can be modeled along with reservoir drainage using the disclosed method for calculating fracture properties. This helps operators improve recovery factor, well, stage, and cluster spacing, as well as inform future re-frac treatments.

Having additional information about stages in the well, a general number or series of number quantities can be assigned to a stage (or well) for comparison purposes. Thus a large number of wells can be evaluated using fracture properties and relating those to production to arrive at preferred or optimal fracturing parameters and configurations.

References cited in the present disclosure include:
Andrew N. Norris (1989), Stoneley-wave attenuation and dispersion in permeable formations, GEOPHYSICS, 54(3), 330-341. https://doi.org/10.1190/1.1442658
Dake, L. P. (1983), Fundamental of Reservoir Engineering, Volume 8. 1st edition. Elsevier Science.
Economides, M., Oligney, R., & Valkó, P. (2002), Unified fracture design: bridging the gap between theory and practice, Orsa Press.
Eric M. Dunham, Jerry M. Harris, Junwei Zhang, Youli Quan, and Kaitlyn Mace (2017), Hydraulic fracture conductivity inferred from tube wave reflections, SEG Technical Program Expanded Abstracts 2017: pp. 947-952. https://doi.org/10.1190/segam2017-17664595.1.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A method for characterizing one or more fracture in a subsurface formation, comprising:
inducing a pressure change in a well drilled through the subsurface formation;
measuring at a location proximate to a wellhead at least one of pressure and a time derivative of pressure in the well for a selected length of time;
measuring fluid pressure in the well with respect to time after a fracture pumping treatment is completed and the well is closed to fluid flow;
measuring volume of fluid and proppant injected to the well;
using said volumes to constrain resulting fracture geometry and/or volume; and
determining at least one of a physical parameter and a change in the physical parameter with respect to time of one or more fractures using the measured at least one of pressure and the time derivative of pressure.

2. The method of claim 1 wherein the inducing a pressure change comprises pumping a fracture treatment.

3. The method of claim 1 wherein the inducing a pressure change comprises water hammer generated by changing a flow rate of fluid into or out of the well.

4. The method of claim 1 wherein the inducing a pressure change comprises operating an acoustic source which injects a pressure pulse into fluid within the well.

5. The method of claim 2 wherein the at least one of a physical parameter, and a change in the physical parameter with respect to time is determined before the pumping treatment.

6. The method of claim 2 wherein the at least one of a physical parameter, and a change in the physical parameter with respect to time is determined during the pumping a fracture treatment.

7. The method of claim 2 wherein the at least one of a physical parameter, and a change in the physical parameter with respect to time is determined after the pumping a fracture treatment.

8. The method of claim 1 further comprising using a model to arrive at near-wellbore conductivity

9. The method of claim 1 further comprising using a model to measure far-field conductivity.

10. The method of claim 9 wherein far-field conductivity has a free parameter of length and a constraint of near-wellbore conductivity.

11. The method of claim 10 wherein a near-wellbore conductivity constrains the far-field conductivity.

12. The method of claim 11 wherein fracture length is calculated based on the constraint of near-wellbore conductivity.

13. The method of claim 1 wherein physical parameters are constrained by volume and composition of a pumped treatment slurry.

14. A method for characterizing one or more fractures in a subsurface formation, comprising:
inducing a pressure change in a well drilled through the subsurface formation;
measuring at a location proximate to a wellhead at least one of pressure and a time derivative of pressure in the well for a selected length of time;
measuring a pressure decay over time after completion of pumping a fracture treatment into the subsurface formation and closing the well to fluid flow;
measuring the volume of fluid and proppant pumped;
using said volumes to constrain resulting fracture volume; and
determining at least one of a physical parameter and a change in the physical parameter with respect to time, of one or more fractures using the measured at least one of pressure and the time derivative of pressure and the measured volume of fluid pumped.

15. The method of claim 13 further comprising determining fracture complexity from time behavior of the other physical parameters.

16. The method of claim 14 wherein fracture complexity is repeatedly determined during pumping of a fracture treatment to optimize fracture treatment parameters.

17. The method of claim 14 wherein fracture complexity is compared among multiple wells or multiple fracture treatment stages to optimize fracture treatment parameters.

18. The method of claim 13 wherein the characteristics are used to improve reservoir and fracture treatment/modes.

19. The method of claim 13 wherein the characterization is used to model at least one of wellbore production, pressure depletion, reservoir drainage, proppant pack permeability and in-situ proppant pack properties.

20. The method of claim 14 where the rate of change of far-field conductivity over time and near field conductivity decline is used to determine at least one of fracture complexity, overflush, and proppant placement.

21. The method of claim 14 where near field and far-field conductivity determinations are used to assign overall production/production rate/production potential, or an average, normalized production of the treatment or treated well for comparison purposes
